(19) United States
(12) Patent Application Publication
(10) Pub. No.: US 2025/0271817 A1
(43) Pub. Date: Aug. 28, 2025

(54) LIGHT CURTAIN SAFETY CASCADING CONTROL PROTOCOL

(71) Applicant: Banner Engineering Corp., Minneapolis, MN (US)

(72) Inventors: Dmitry Gringauz, Minneapolis, MN (US); Mike Lunacek, Minneapolis, MN (US); Greg Anderson, Minneapolis, MN (US); Michael Shawn Bechtold, Minneapolis, MN (US)

(73) Assignee: Banner Engineering Corp., Minneapolis, MN (US)

(21) Appl. No.: 19/061,484

(22) Filed: Feb. 24, 2025

Related U.S. Application Data
(60) Provisional application No. 63/559,103, filed on Feb. 28, 2024.

(51) Int. Cl. G05B 9/02; G05B 19/418

(52) U.S. Cl. CPC G05B 9/02; G05B 19/4185

(57) ABSTRACT

Apparatus and associated methods relate to a cascading safety network configured to address each safety device in a multi-drop protocol. In an illustrative example, a cascading safety network (CSN) may include a server device connected a serially connected sequence of client safety devices. The CSN, for example, may include a communication line having a multi-drop layer and a enumeration layer connecting to each of the safety devices in the CSN. For example, in operation, each of the at least one client safety device is directly addressable by the server device through a client address uniquely assigned by the server device. When the server device detects a change in the client node sequence, the server device is triggered to perform safe state operations to automatically configure the cascaded multi-drop safety network. Various embodiments may advantageously allow automatic configuration of the CSN without physical switches and/or external software tools.

### CROSS-REFERENCE TO RELATED APPLICATIONS

This application claims the benefit of U.S. Provisional Application Ser. No. 63/559,103, titled “LIGHT CURTAIN SAFETY CASCADING CONTROL PROTOCOL,” filed by Dmitry Gringauz, et al., on Feb. 28, 2024.

This application incorporates the entire contents of the foregoing application(s) herein by reference.

### TECHNICAL FIELD

Various embodiments relate generally to automatically configure and monitor a safety monitoring and control network.

### BACKGROUND

Safety monitoring devices are essential components in industrial settings. For example, the safety monitoring device may prevent accidents and injuries by detecting and responding to hazardous conditions. In some examples, an industrial setting may include one or more safety monitoring devices including light curtains, safety mats, laser scanners, and other sensors that detect the presence of people or objects in dangerous areas. Some safety monitoring devices may be designed to provide a high level of safety and reliability. In some cases, the safety monitoring devices may be used in conjunction with other safety measures (e.g., emergency stop buttons and safety interlocks).

In some examples, some safety monitoring devices may be mandated by industrial standards. For example, the industrial standard may regulate a proper implementation and maintenance for safety of workers and equipment. In some cases, an implementation of safety monitoring devices in complex industrial environments may be interconnected.

### SUMMARY

Apparatus and associated methods relate to a cascading safety network configured to address each safety device in a multi-drop protocol. In an illustrative example, a cascading safety network (CSN) may include a server device connected a serially connected sequence of client safety devices. The CSN, for example, may include a communication line having a multi-drop layer and a enumeration layer connecting to each of the safety devices in the CSN. For example, in operation, each of the at least one client safety device is directly addressable by the server device through a client address uniquely assigned by the server device. When the server device detects a change in the client node sequence, the server device is triggered to perform safe state operations to automatically configure the cascaded multi-drop safety network. Various embodiments may advantageously allow automatic configuration of the CSN without physical switches and/or external software tools.

Apparatus and associated methods relate to automatically configure and monitor a cascade safety monitoring and control network (CSMCN) of an unknown number of safety monitoring device (SMD). In an illustrative example, a host device may include an enumeration connection and a multi-drop communication connection embedded in a single cable. In a discovery mode, for example, the host device may activate, from i=1, an i-th enumeration line operably couple between an i-th and the (i+1)-th SMD. The host device may, for example, transmit a discover message to assign an address i to the i-th serial enumeration line. The number i may be incremented until all N SMD are discovered. In a run mode, the host device may address each of the SMD using the assigned address on the communication connection. Various embodiments may advantageously provide a protocol for a CSMCN of SMDs to communicate with address-based safety signals.

Various embodiments may achieve one or more advantages. For example, some embodiments may be embedded in a standard (e.g., 5-pin) industry standard cable. Some embodiments may, for example, be robust against device fault within the CSMCN. For example, some embodiments may provide a consistent address assignment based on physical topology in the CSMCN. Some embodiments, for example, may advantageously remove on-site setup procedures. For example, some embodiments may advantageously allow flexibility in installing safety devices. Some embodiments may, for example, advantageously reduce cabling to a control panel. For example, some embodiments may advantageously be prone to error of one or more of the SMDs in the CSMCN.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary cascading safety network (CSN) employed in an illustrative use-case scenario.

FIG. 2 is a block diagram depicting an exemplary machine controlling and safety monitoring device.

FIG. 3 is a flowchart illustrating an exemplary CSN automatic configuration method.

FIG. 4 is a flowchart illustrating an exemplary CSN device configuration and verification method.

FIG. 5 is a flowchart illustrating an exemplary CSN safety monitoring and control method.

Like reference symbols in the various drawings indicate like elements.

### DETAILED DESCRIPTION OF ILLUSTRATIVE EMBODIMENTS

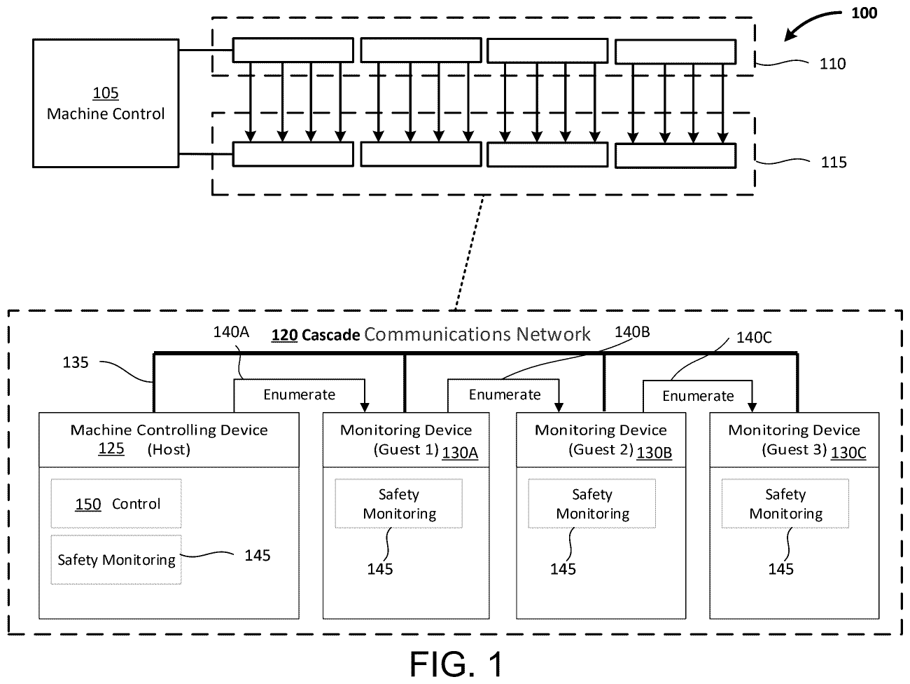

FIG. 1 depicts an exemplary cascading safety network (CSN) employed in an illustrative use-case scenario. In this example, a CSN 100 is connected to a machine control 105. For example, the CSN 100 may generate a safety signal to the machine control 105 based on a safety measurement of the CSN 100. In this example, the CSN 100 may include a cascaded light curtain system. The cascaded light curtain system may include serially connected emitters 110 and serially connected receivers 115. For example, each of the serially connected receivers 115 may receive a corresponding light beam emitted from a corresponding one of the serially connected emitters 110. For example, based on the light beam received from the serially connected emitters 110, the serially connected receivers 115 may generate a signal to the machine control 105 to report a safety status (e.g., normal, abnormal). In some examples, the machine control 105 may, based on the safety status indicating an abnormal situation received from the serially connected receivers 115, generate an emergency stop signal to a machine. Various embodiments may advantageously provide a protocol for a cascade system of light curtains (e.g., or similar safety monitoring devices) to communicate address-based safety signals and controls signals within the cascade system.

As an illustrative example shown in FIG. 1, the CSN 100 may include a cascade communication network (CCN 120). The CCN 120 includes, in this example, a host monitoring device 125 and three guest monitoring devices (a first guest device 130A, a second guest device 130B, a third guest device 130C). For example, the first guest device 130A, the second guest device 130B, and the third guest device 130C may be connected in a cascading (e.g., a serially connected) network.

In this example, each of the host monitoring device 125, the first guest device 130A, the second guest device 130B, and the third guest device 130C includes a safety monitoring module 145. For example, the safety monitoring module 145 may be configured to provide safety monitoring function of a safety device. For example, for the serially connected receivers 115, the safety monitoring module 145 may include function to monitor changes in the received light beams from the serially connected emitters 110.

The host monitoring device 125 also include a control module 150. In some implementations, the control module 150 may include an output signal switching device (OSSD) controller. In some implementations, the control module 150 may generate safety information and diagnosis information to the machine control 105. For example, the control module 150 may generate safety control signals to a connected machinery (e.g., the machine control 105) using OSSD. For example, the control module 150 may generate control signals using other machinery control protocols. In some implementations, the control module 150 may also generate control signals to one or more of the guest monitoring devices 130A-C. For example, the control signals may request the guest monitoring devices 130A-C to report an updated safety status to the host monitoring device 125 using a communication line 135. In various implementations, the CCN 120 may include the communication line 135 that connect to parallelly connect the first guest device 130A, the second guest device 130B and the third guest device 130C to the host monitoring device 125.

Using the communication line 135, for example, the host monitoring device 125 and the guest monitoring device may transmit and receive safety activation and diagnostic information. For example, the host monitoring device 125 may receive safety and diagnostic information from one of the guest monitoring devices 130A-C by addressing one of them directly. For example, the communication line 135 may be configured to operate over a communications physical layer supporting a multi-drop network topology (e.g., RS-485, Controller Area Network (CAN), Modbus, Profibus, Ethernet with Daily Chain Topology, or similar physical layer supporting multi-drop topology). For example, the communication line 135 may use a multi-drop protocol instead of a pass-through protocol to communicate signals with each device.

As shown, the CCN 120 also includes enumeration lines 140A, 140B, 140C between each of the serially connected devices (the enumeration line 140A between the host monitoring device 125 and the first guest device 130A, the enumeration line 140B between the first guest device 130A and the second guest device 130B, and the enumeration line 140C between the second guest device 130B and the third guest device 130C). In some implementations, the enumeration lines 140A-C may include a single-wire point-to-point connection between devices. For example, the enumeration lines 140A-C may support a daisy-chain network topology. For example, the enumeration lines 140A-C may advantageously be used during an auto-configuration process (e.g., during a power-up sequence to enable Guest communications). In some examples, the CCN 120 may include two physical line connections between each adjacent devices. For example, the two physical line connections may advantageously be embedded in a standard (e.g., 5-pin) industry standard cable.

In some implementations, the host monitoring device 125 and the guest monitoring devices 130A-C may each have independent access to the communication line 135. For example, the CCN 120 may advantageously be robust against device fault within the CSN 100. For example, when the second guest device 130B is broken, the third guest device 130C may retain communication with the host monitoring device 125 because the third guest device 130C has access to the communication line 135.

In some implementations, in an auto-configuration process, the control module 150 of the host monitoring device 125 may assign address to an unknown number (N>=0) of the guest monitoring devices 130A-C sequentially. For example, the control module 150 may assign a first address to the first guest device 130A first. Then, the control module 150, for example, assign a second address to the second guest device 130B. In various examples, the enumeration lines 140A-C may advantageously provide a consistent address assignment based on physical topology in the CSN 100. For example, the CCN 120 having the auto-configuration process may advantageously remove on-site setup procedures. For example, there may have no need to configure a switch for connecting the host monitoring device 125 and the guest monitoring devices 130A-C. For example, the host monitoring device 125 and the guest monitoring devices 130A-C may have a clean outlook without user configuration interface (e.g., dip switches).

In various embodiments, the control module 150 may include a safety communication protocol for cascading (connecting) multiple safety monitoring devices. For example, the control module 150 may automatically configure the CCN 120 without the use of physical switches or external software tools. For example, the control module 150 may transfer safety activation and diagnostic information from all safety monitoring devices that are part of the CCN 120. For example, the control module 150 may allow efficient (e.g., easy, quick, hot-swap, low cost, low labor) device replacement if one of the devices on the safety network malfunctions.

In various implementations, the host monitoring device 125 of the CSN 100 may use a single cable to provide a multidrop communication layer (e.g., the communication line 135) and a enumerated line addressing layer (e.g., the enumeration lines 140A-C) to communicate with all guest devices within the CCN 120. For example, the CSN 100 may advantageously allow flexibility in installing safety devices. For example, the CSN 100 with cascading connected devices may extend safety protection to physical areas where a single device may not be capable of providing enough coverage. For example, the CSN 100 may extend the safety protection to physical areas where an installation physical layout is not linear. Various implementations may advantageously reduce cabling to a control panel (e.g., the machine control 105).

In various embodiments, a safety device communication system (e.g., the CSN 100) may include a single communication link (e.g., the communication line 135) configured to connect all devices in the safety device communication system to form a multi-drop network. For example, a server node (e.g., the host monitoring device 125) may be connected to one or more client nodes (e.g., the guest monitoring devices 130A-C) in a sequential manner forming a cascading network forming a client node sequence. For example, in operation, the server node enters in to a safe state when the server node detects changes in any of the client nodes.

For example, the safety device communication system may include N enumerate links (e.g., the enumeration lines 140A, 140B, 140C), where N is the number of client nodes. For example, the 1^{st} enumerate link may connect the server node to the 1^{st} client node, and the i-th enumerate link connect the (i−1)-th client node to the i-th client node.

During the safe state triggered by the detected changes, for example, the server node of the safety device communication system may reset each of the client nodes to a discovery address. For example, the server node may sequentially and incrementally assigns an operating address of each of the multiple node based on the node sequence.

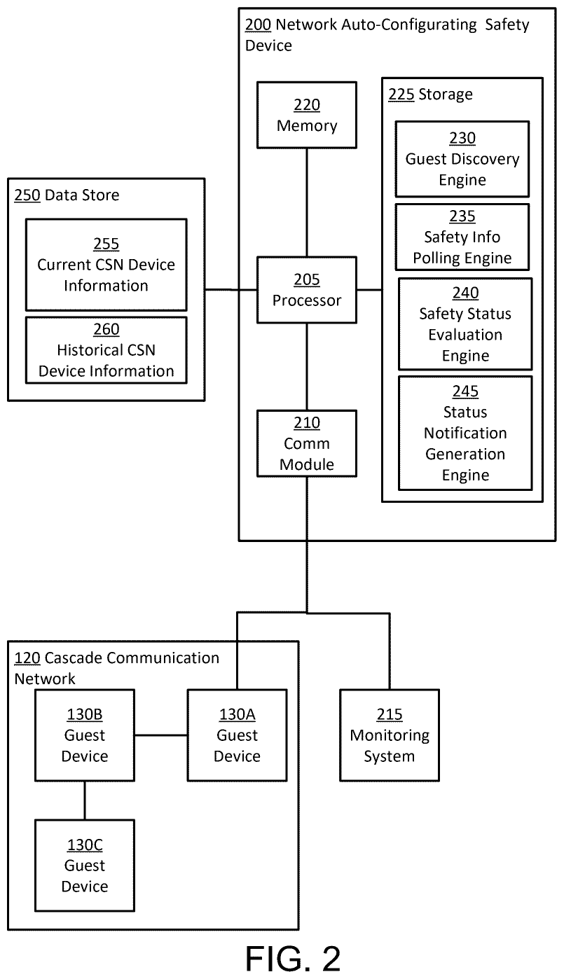

FIG. 2 is a block diagram depicting an exemplary network auto-configuring safety device (NACSD 200). For example, the NACSD 200 may include the host monitoring device 125 as described in FIG. 1. For example, the NACSD 200 may include the control module 150 of the host monitoring device 125. In this example, the NACSD 200 includes a processor 205. The processor 205 may, for example, include one or more processing units. The processor 205 is operably coupled to a communication module 210. The communication module 210 may, for example, include wired communication. The communication module 210 may, for example, include wireless communication. In various examples, the communication module 210 may include a connection to a communication network using a protocol supporting a multi-drop topology. In some examples, the communication module 210 may include a connection to a standard industrial cable. For example, the communication module 210 may be include a connection to a cable having a communication line (e.g., the communication line 135) and an enumeration line (e.g., the enumeration line 140A)

In the depicted example, the communication module 210 is operably coupled to a monitoring system 215. For example, the monitoring system 215 may be configured to receive safety status from a cascade network hosted by the NACSD 200. For example, the monitoring system 215 may include the machine control 105. For example, the monitoring system 215 may, based on information received from the NACSD 200, generate control signals to other safety devices and/or machines. The communication module 210 is also connected to the first guest device 130A. As shown, the first guest device 130A is serially connected to the second guest device 130B, and the second guest device 130B is connected serially to the third guest device 130C, forming the CCN 120.

The processor 205 is operably coupled to a memory module 220. The memory module 220 may, for example, include one or more memory modules (e.g., random-access memory (RAM)). The processor 205 includes a storage module 225. The storage module 225 may, for example, include one or more storage modules (e.g., non-volatile memory). In the depicted example, the storage module 225 includes a guest discovery engine (GDE 230), a safety information polling engine (SIPE 235), a safety status evaluation engine (SSEE 240), and a status notification generation engine (SNGE 245). In some embodiments, the control module 150 described in FIG. 1 may perform one or more processes stored in the storage module 225.

For example, the GDE 230 may be configured to assign addresses to devices in the CCN 120. In some implementations, the GDE 230 may also be configured guest device functionality in the CCN 120. The SIPE 235, for example, may be operated in a run mode of the CCN 120. In some examples, the SIPE 235 may poll safety information from each of the guest devices in the CCN 120 (e.g., in a round-robin style, in a selective polling style based on device type and version, in a dynamic polling style).

The SSEE 240, for example, may be configured to evaluate the safety information received from the CCN 120. In some examples, the SSEE 240 may combine the safety information with a safety measurement of the NACSD 200 (e.g., the host monitoring device 125). As an illustrative example, in the CSN 100, the SSEE 240 may determine which of the light curtains is compromised based on the received safety information from the serially connected emitters 110 and the serially connected receivers 115. For example, the SNGE 245 may generate notification messages to the monitoring system 215 based on evaluation result of the SSEE 240.

The processor 205 is further operably coupled to a data store 250. The data store 250 includes a current CSN device information 255 and historical CSN device information 260. For example, after a guest device discovery process, the GDE 230 may save the current CSN device information 255 to the data store 250. For example, the current CSN device information 255 may include a total number of devices within the CSN 100. In some embodiments, the current CSN device information 255 may include also device type and version at each address in the CSN 100. In some implementations, the GDE 230 may retrieve one or more of the historical CSN device information 260 saved in previous discovery process (e.g., from a previous power cycle) to verify the current CSN device information 255.

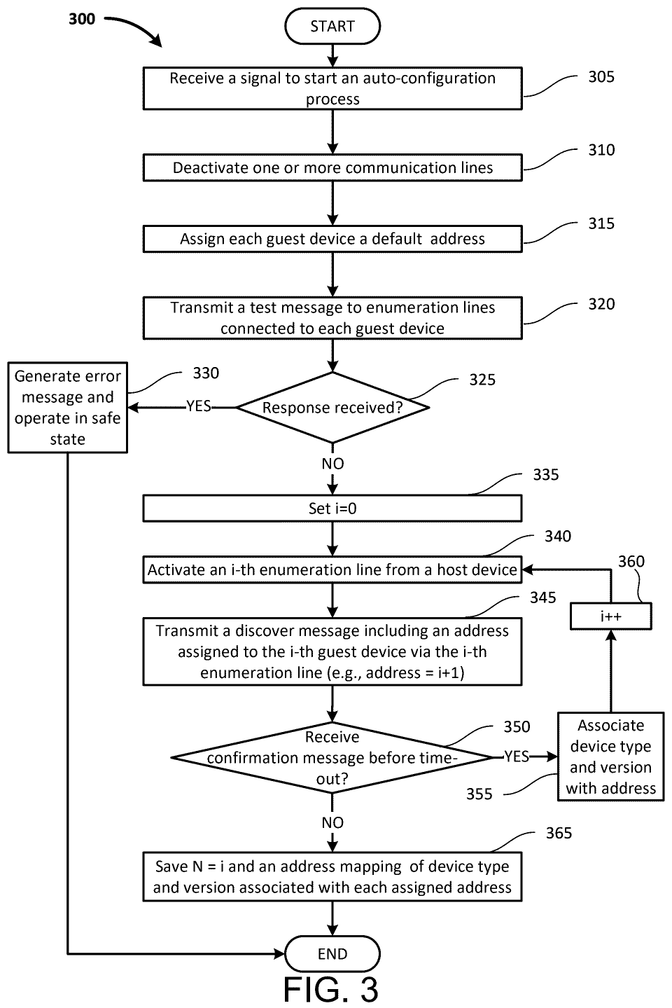

FIG. 3 is a flowchart illustrating an exemplary CSN automatic configuration method 300. The control module 150, for example, may perform the method 300. For example, the method 300 may be performed by the GDE 230 as described with reference to FIG. 2. In some implementations, the GDE 230 may be invoked to perform the method 300 when a network discover process is required.

In this example, the method 300 begins in step 305 when a signal is received to start an automatic configuration process. For example, an automatic configuration signal may be received by the control module 150 when the CSN 100 is powered up. For example, the automatic configuration signal may be received from a remote device. Next, in step 310, all communication lines are deactivated. For example, the control module 150 may deactivate the communication line 135. After all communication lines are deactivated, each guest device is assigned a default address in step 315. For example, the default address may be an out-of-bound address. For example, the GDE 230 may include an predetermined address range (e.g., 0-7, 1-128, 0-255, 1-250). For example, the GDE 230 may assign an address >250 to all guest devices. In step 320, a test message is transmitted to enumeration lines connected to each guest device. For example, the control module 150 may transmits a test message to the first guest device 130A, the second guest device 130B, and the third guest device 130C, through the enumeration line 140A, the enumeration lines 140B, and the enumeration lines 140C, respectively.

In a decision point 325, it is determined whether a response is received from any of the guest devices. If any response is received, in step 330, an error message is generated and the system is operated in a safe state, and the method 300 ends. If no response is received, a variable i is set to 0 in step 335.

Next, an i-th enumeration line is activated in step 340. For example, the control module 150 may activate the enumeration line 140A connected to the first guest device 130A. In some implementations, this may enable the first guest device 130A to receive message from the CSN 100.

In step 345, a discover message including an address assigned to the i-th enumeration line is transmitted to the i-th enumeration line. For example, the control module 150 may transmit the discover message using the enumeration line 140A and the default address. For example, the control module 150 may assign the first address as 1. For example, the assigned address may be linearly increasing (e.g., address=i+1). In other implementations, the control module 150 may not need to save a full address mapping including all assigned address corresponding to each device. For example, the control module 150 may address the guest devices in the CSN 100 based on a predetermined assignment formula (e.g., a uniquely increasing address for each device appended to an end of a serially connection chain in the CSN 100). In some examples, other assignment formula (e.g., using increasing odd numbers, even numbers, or an algorithm based formula) may be used.

In a decision point 350, it is determined whether a confirmation message is received before time-out (e.g., a predetermined time threshold). For example, a device accepted the assigned address may transmit a confirmation message to the host monitoring device 125. For example, when there is no more devices without an address (e.g., when the third guest device 130C is already discovered in the CCN 120), the control module 150 may receive no confirmation message in response to the discover message. In some implementations, after accepting the assigned address, a guest device may stop responding to messages sent to the default address.

If a confirmation message is received before time-out, in step 355, a device type and version is associated with the assigned address. For example, the confirmation message may include also the device type and version information. In step 360, i=i+1, and the step 340 is repeated. If no confirmation message is received before time-out, an address mapping of device type and version associated with each assigned address and N=i are saved in step 365, and the method 300 ends. For example, the current CSN device information 255 is saved in the data store 250. For example, a total number of devices connected to the CSN 100 may be saved. In various embodiments, after the method 300 is completed successfully, each guest device in the CCN 120 may be assigned a unique linear address assigned to them that is not the default address.

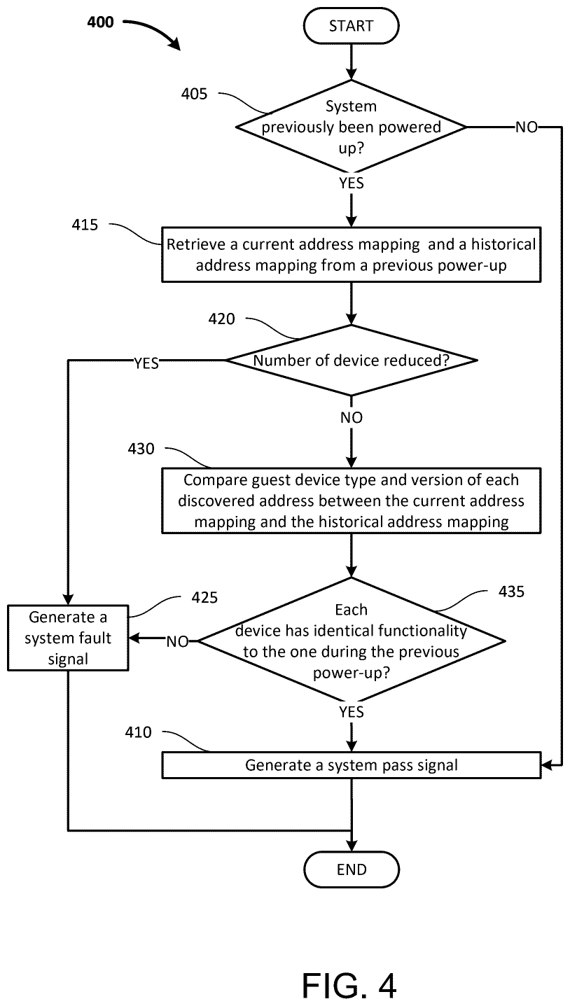

FIG. 4 is a flowchart illustrating an exemplary CSN device configuration and verification method 400. For example, the control module 150 may use the GDE 230 to perform the method 400 to configure devices in a CSN (e.g., the guest devices 130A-C in the CCN 120). In this example, the method 400 begins in a decision point 405 determining whether a system has previously been powered up. For example, a system has not previously been powered up if the system is newly assembled. For example, the control module 150 may receive a signal (e.g., a status flag in the host monitoring device 125) indicating that the CSN 100 is newly assembled. If the system has not previously been powered up, a system pass signal is generated in step 410, and the method 400 ends. For example, if the system has not previously been powered up, the host monitoring device 125 may persist a discovered system configuration (e.g., stored in the current CSN device information 255).

If the system has previously been powered up, a current address mapping and a historical address mapping from a previous power up are retrieved in step 415. For example, the GDE 230 may retrieve the current CSN device information 255 and the historical CSN device information 260. For example, the address mapping may include device type and a device version of each of the guest devices in the network.

In a decision point 420, it is determined whether a number of guest devices is reduced. In some implementations, the host monitoring device 125 may allow adding new guest devices but not remove any guest devices from an existing network. If the number of guest devices is reduced, a system fault signal is generated in step 425, and the method 400 ends.

If the number of guest devices is not reduced, in step 430, guest device type and version of each discovered address between the current address mapping and the historical address mapping are compared. For example, the type and version of each of the light curtains in the CSN 100 may be compared. In a decision point 435, it is determined if each guest device has identical functionality to the one during the previous power-up. For example, the GDE 230 may compare the retrieved current address mapping and the retrieved historical address mapping. If it is determined that if each guest device has identical functionality to the one during the previous power-up, the system pass signal is generated in step 410 and the method 400 ends.

If any guest device has non-identical functionality to the one during the previous power-up, the system fault signal is generated in the step 425 and the method 400 ends. In various implementations, if it is necessary to replace one of the devices in the CSN 100, the GDE 230 may permit only a functionally identical device to be implemented. If a mismatch is detected, for example, the GDE 230 may declare a failure status and transition the CSN 100 to operate in a safe state.

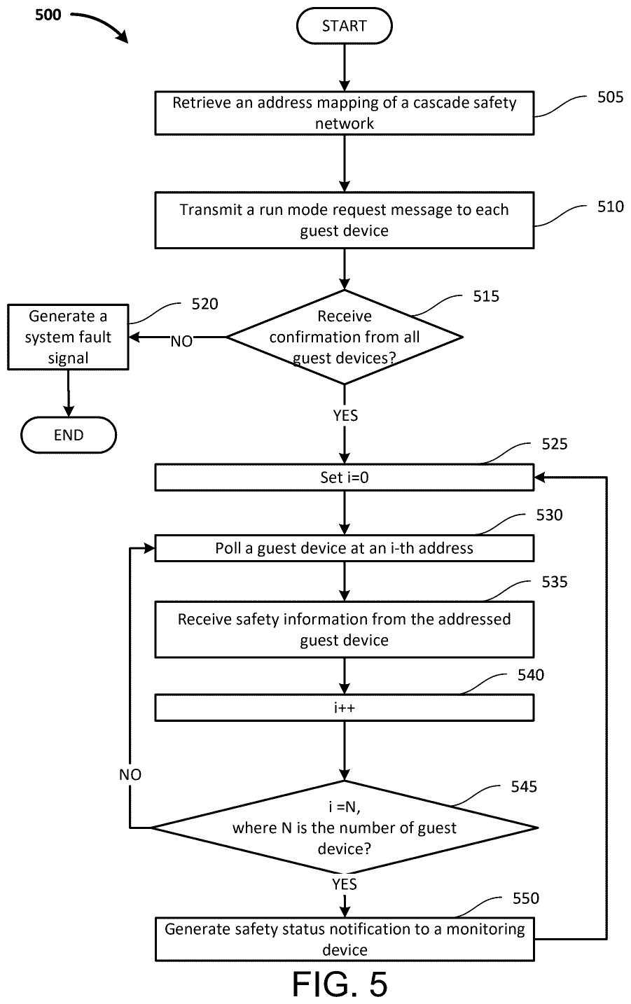

FIG. 5 is a flowchart illustrating an exemplary CSN safety monitoring and control method 500. For example, the control module 150 may perform the method 500 to monitor safety status within the CSN 100. In some embodiments, the control module 150 may start the method 500 upon receiving a control signal from a remote device in the CSN 100. In some implementations, the method 500 may be activated upon completion of the method 300. In some implementations, the method 500 may be activated upon completion of the method 400. For example, the control module 150 may use the SIPE 235, the SSEE 240, and the SNGE 245 to perform the method 500. In this example, the method 500 begins in step 505 when an address mapping of a cascade safety network is retrieved. For example, the control module 150 may retrieve from the data store 250 the current CSN device information 255 of the CSN 100.

In step 510, a run mode request message is transmitted to each guest device. For example, the SIPE 235 may transmit the run mode request message based on addresses in the current CSN device information 255. In a decision point 515, it is determined whether confirmation is received from all guest devices. For example, the guest devices (e.g., the first guest device 130A, the second guest device 130B, and the third guest device 130C) may transmit acknowledgement messages to the host monitoring device 125 when the run mode request message is received. For example, the confirmation may include a “ready to run” signal indicating that a corresponding device is powered up.

If the confirmation messages is not received from all guest devices, in step 520, a system fault signal is generated in step 520, and the method 500 ends. For example, the system fault signal may indicate an address (e.g., indicative of the position in a serially connected network of guest devices) of a guest device that does not transmit the acknowledgement message. In some implementations, the system fault signal may trigger the host monitoring device 125 to perform automatic configuration (e.g., the method 300) to automatically cure a potential problem.

If confirmation messages is received from all guest devices, in step 525, i is set to 0. Next, a guest address with an i-th address is polled. For example, the SIPE 235 may poll the first guest device 130A at the 0 address. In step 535, safety information is received form the addressed guest device. For example, at i=1, the second guest device 130B may transmit a safety status (e.g., activated, failsafe) to the host monitoring device 125. After the safety information is received, i=i+1 in step 540. In some implementations, the CSN 100 may work if one or more of the discovered guest devices are at fault. For example, the host monitoring device 125 may wait for a predetermined time for the safety information. In some examples, without receiving the safety information, the control module 150 may proceed to next step in the method 500. Accordingly, for example, the control module 150 may advantageously be prone to error of one or more of the guest devices in the CSN 100.

In a decision point 545, it is determined whether i=N where N is the number of guest device in the CSN. For example, in the CSN 100, N=3. For example, if i=N, that means all guest devices may be polled once. If i≠N, the step 530 is repeated.

If i=N, a safety status notification is generated to a monitoring device in step 550. For example, the SSEE 240 may determine, based on an overall safety state, a safety status result. In some examples, the SNGE 245 may generate a notification based on the safety status result to a monitoring device (e.g., the machine control 105, the monitoring system 215).

Although various embodiments have been described with reference to the figures, other embodiments are possible.

Any group of safety devices that can be combined to create a dedicated safety network for the purpose of extending safety function coverage.

Although an exemplary system has been described with reference to FIG. 1, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative example, a cascading safety network may include a server device, at least one client safety device, a communication line configured to connect the server device and the at least one client safety device to form a cascaded multi-drop safety network. For example, the cascaded multi-drop safety network may include the server device connected to a first client safety device of the client safety device.

For example, the cascaded multi-drop safety network may include each of the at least one client safety device, except the first client safety device and a last client safety device, connected to a previous client safety device and a next client safety device. For example, the communication line may include N enumeration lines, where N may be the number of the at least one client safety device. For example, the 1st enumeration line connects the server device to the 1st client safety device, and the i-th enumeration line connect the (i−1)-th client node to the i-th client safety device.

For example, in operation, each of the at least one client safety device may be directly addressable by the server device through a client address uniquely assigned by the server device. For example, the server device may be triggered to perform safe state operations to automatically configure the cascaded multi-drop safety network when the server device detects a change in the client node sequence.

For example, the safe state operations may include reset the client address of each of the client nodes to a discovery address. For example, the safe sate operations may include activate the enumeration line sequentially and incrementally an i-th enumeration line from the 1^{st} enumeration line to the N-th enumeration line, and assign a new client address to the i-th client safety device connected by the i-th enumeration line. For example, the at least one client safety device may be changeable without rebooting the server device.

For example, the safe state operations may include deactivate the communication line. For example, the safe state operations may include set i=1. For example, the safe state operations may include perform discovery operations.

For example, the discovery operations may include activate an i-th enumeration line. For example, the discovery operations may include transmit a discover message comprising an assigned address to the i-th safety monitoring device via the i-th enumeration line. For example, the discovery operations may include, when no response may be received from the i-th enumeration line after a predetermined time threshold, determine that there may be N=(i−1) client safety device serially connected to the server device and save N in a first data store.

For example, the discovery operations may include, when a confirmation message may be received from the i-th enumeration line, then associate an i-th assigned address with the i-th guest safety monitoring device, set i=i+1, and repeat the discovery operations.

For example, after transmitting discover message to the i-th serial enumeration line, if no confirmation message may be received from the i-th serial enumeration line after a predetermined time threshold, save an address mapping in a second data store. For example, the address mapping may include a device type and a device version of each of the at least one guest safety monitoring device connected in the cascade safety network.

For example, the server device may be configured to perform safety monitoring operations. For example, the safety monitoring operations may include receive ready signals from each of the at least one client safety device. For example, the safety monitoring operations may include set i=1. For example, the safety monitoring operations may include perform safety polling operations.

For example, the safety polling operations may include poll an i-th client safety device of the cascaded multi-drop safety network by transmitting a request to the client address associated with the i-th client. For example, the safety polling operations may include receive safety and diagnostic information from the i-th client safety device. For example, the safety polling operations may include determine whether all of the at least one client safety device may be polled based on the number N saved in the first data store.

For example, the safety polling operations may include, when not all of the at least one client safety device may be polled, set i=i+1 and repeat the safety polling operations. For example, the safety polling operations may include, when all of the at least one client safety device may be polled, generate a safety status message based on safety and diagnostic information received from each of the at least one client safety device.

For example, the safety monitoring operations may include retrieve a historic guest device number of from a safety monitoring and control network configuration. For example, the historic guest device number may include a historical total number of the at least one guest safety monitoring device identified in the safety monitoring and control network configuration. For example, the safety monitoring operations may include, when the historic guest device number may be greater than the total number of the at least one guest safety monitoring device, generate an error signal to trigger the safe state operations. For example, the server device and/or the at least one client safety device comprise safety light curtains.

In an illustrative aspect, a cascading safety network may include a server device, at least one client safety device, and/or a communication line configured to connect the server device and the at least one client safety device to form a cascaded multi-drop safety network. For example, the cascaded multi-drop safety network may include the server device connected to a first client safety device of the client safety device. For example, the cascaded multi-drop safety network may include each of the at least one client safety device, except the first client safety device and a last client safety device, connected to a previous client safety device and a next client safety device.

For example, in operation, each of the at least one client safety device may be directly addressable by the server device through a client address uniquely assigned by the server device. For example, the server device may be triggered to perform safe state operations to automatically configure the cascaded multi-drop safety network when the server device detects a change in the client node sequence.

For example, the communication line may include N enumeration lines, where N may be the number of the at least one client safety device. For example, the 1st enumeration line connects the server device to the 1st client safety device, and the i-th enumeration line connect the (i−1)-th client node to the i-th client safety device.

For example, the safe state operations may include reset the client address of each of the client nodes to a discovery address. For example, the safe state operations may include activate the enumeration line sequentially and incrementally an i-th enumeration line from the 1st enumeration line to the N-th enumeration line, and assign a new client address to the i-th client safety device connected by the i-th enumeration line. For example, the at least one client safety device may be changeable without rebooting the server device.

For example, the safe state operations may include deactivate the communication line. For example, the safe state operations may include set i=1. For example, the safe state operations may include perform discovery operations.

For example, the discovery operations may include activate an i-th enumeration line. For example, the discovery operations may include transmit a discover message comprising an assigned address to the i-th safety monitoring device via the i-th enumeration line. For example, the discovery operations may include, when no response may be received from the i-th enumeration line after a predetermined time threshold, determine that there may be N=(i−1) client safety device serially connected to the server device and save N in a first data store.

For example, the discovery operations may include, when a confirmation message may be received from the i-th enumeration line, then associate an i-th assigned address with the i-th guest safety monitoring device, set i=i+1, and repeat the discovery operations.

For example, after transmitting discover message to the i-th serial enumeration line, if no confirmation message may be received from the i-th serial enumeration line after a predetermined time threshold, save an address mapping in a second data store. For example, the address mapping may include a device type and a device version of each of the at least one guest safety monitoring device connected in the cascade safety network.

For example, the service device may be configured to perform a safety monitoring operations. For example, the safety monitoring operations may include receive ready signals from each of the at least one client safety device. For example, the safety monitoring operations may include set i=1. For example, the safety monitoring operations may include perform safety polling operations.

For example, the safety polling operations may include poll an i-th client safety device of the cascaded multi-drop safety network by transmitting a request to the client address associated with the i-th client. For example, the safety polling operations may include receive safety and diagnostic information from the i-th client safety device. For example, the safety polling operations may include determine whether all of the at least one client safety device may be polled based on the number N saved in the first data store.

For example, the safety polling operations may include, when not all of the at least one client safety device may be polled, set i=i+1 and repeat the safety polling operations. For example, the safety polling operations may include, when all of the at least one client safety device may be polled, generate a safety status message based on safety and diagnostic information received from each of the at least one client safety device.

For example, the safety monitoring operations may include retrieve a historic guest device number of from a safety monitoring and control network configuration. For example, the historic guest device number may include a historical total number of the at least one guest safety monitoring device identified in the safety monitoring and control network configuration. For example, the safety monitoring operations may include when the historic guest device number may be greater than the total number of the at least one guest safety monitoring device, generate an error signal to trigger the safe state operations.

For example, the server device and/or the at least one client safety device comprise safety light curtains.

In an illustrative example, a computer-implemented method performed by at least one processor to automatically configure and monitor a multi-drop safety monitoring and control network having an unknown N guest safety monitoring devices. For example, the method may include deactivate a communication line configured to serially connect other safety monitoring device. For example, the communication line may include a serial enumeration connection and a parallel communication connection embedded in a single cable.

For example, the method may include set i=0. For example, the method may include perform discovery operations. For example, the discovery operations may include activate an i-th enumeration line. For example, the i-th serial enumeration line may be operably couple between an (i−1)-th safety monitoring device and an i-th safety monitoring device from a host safety monitoring device. For example, an “0-th” safety monitoring device may be the server device and the i-th safety monitoring device, where i>0, indicate an i-th guest safety monitoring device serially connected to the host safety monitoring device.

For example, the discovery operations may include transmit a discover message comprising an assigned address to the i-th safety monitoring device via the i-th enumeration line. For example, the discovery operations may include, when no response may be received from the i-th enumeration line after a predetermined time threshold, determine that there may be N guest safety monitoring devices serially connected to the server device and save N in a second data store. For example, the discovery operations may include, when a confirmation message may be received from the i-th enumeration line, then (1) associate the assigned address with the i-th guest safety monitoring device, (2) set i=i+1, and (3) repeat the discovery operations.

For example, the method may include receive ready signals from each of the N guest safety monitoring devices serially connected to the host safety monitoring device. For example, the method may include set i=1. For example, the method may include perform safety polling operations.

For example, the safety polling operations may include poll an i-th guest safety monitoring device of the N guest safety monitoring devices serially connected to the server device by transmitting a request to address i through the parallel communication connection. For example, the safety polling operations may include receive safety and diagnostic information from the i-th guest safety monitoring device. For example, the safety polling operations may include determine whether all of the N guest safety monitoring devices may be polled. For example, the safety polling operations may include, if not all of the N guest safety monitoring devices serially connected to the server device may be polled, set i=i+1 and repeat the safety polling operations, and if all of the N guest safety monitoring devices serially connected to the server device may be polled, generate a safety status message based on safety and diagnostic information received from the N guest safety monitoring devices.

For example, the parallel communication connection may include a multi-drop communication network.

For example, after transmitting discover message to the i-th enumeration line, if no confirmation message may be received from the i-th enumeration line after a predetermined time threshold, save an address mapping in a second data store. For example, the address mapping may include a device type and a device version of each of the N guest safety monitoring devices serially connected to the host safety monitoring device.

For example, the method may include retrieve a historic guest device number of from a safety monitoring and control network configuration. For example, the historic guest device number may include a historical total number K equals to a number of guest safety monitoring devices serially connected to the server device identified in the safety monitoring and control network configuration. For example, the method may include if K>N, generate an error signal.

In a first illustrative aspect, a cascading safety network may include a server device, at least one client safety device, a communication line configured to connect the server device and the at least one client safety device to form a cascaded multi-drop safety network. For example, the cascaded multi-drop safety network may include the server device connected to a first client safety device of the client safety device.

For example, the cascaded multi-drop safety network may include each of the at least one client safety device, except the first client safety device and a last client safety device, connected to a previous client safety device and a next client safety device. For example, the communication line may include N enumeration lines, where N may be the number of the at least one client safety device. For example, the 1st enumeration line connects the server device to the 1st client safety device, and the i-th enumeration line connect the (i−1)-th client node to the i-th client safety device.

For example, in operation, each of the at least one client safety device may be directly addressable by the server device through a client address uniquely assigned by the server device. For example, the server device may be triggered to perform safe state operations to automatically configure the cascaded multi-drop safety network when the server device detects a change in the cascaded multi-drop safety network.

For example, the cascading safety network may include none, one, or more of the following features:
For example, the safe state operations may include reset the client address of each of the client nodes to a discovery address. For example, the safe sate operations may include activate the enumeration line sequentially and incrementally an i-th enumeration line from the 1^{st} enumeration line to the N-th enumeration line, and assign a new client address to the i-th client safety device connected by the i-th enumeration line. For example, the at least one client safety device may be changeable without rebooting the server device.
For example, the safe state operations may include deactivate the communication line. For example, the safe state operations may include set i=1. For example, the safe state operations may include perform discovery operations.
For example, the discovery operations may include activate an i-th enumeration line. For example, the discovery operations may include transmit a discover message comprising an assigned address to the i-th safety monitoring device via the i-th enumeration line. For example, the discovery operations may include, when no response may be received from the i-th enumeration line after a predetermined time threshold, determine that there may be N=(i−1) client safety device serially connected to the server device and save N in a first data store.
For example, the discovery operations may include, when a confirmation message may be received from the i-th enumeration line, then associate an i-th assigned address with the i-th guest safety monitoring device, set i=i+1, and repeat the discovery operations.
For example, after transmitting discover message to the i-th serial enumeration line, if no confirmation message may be received from the i-th serial enumeration line after a predetermined time threshold, save an address mapping in a second data store. For example, the address mapping may include a device type and a device version of each of the at least one guest safety monitoring device connected in the cascade safety network.
For example, the server device may be configured to perform safety monitoring operations. For example, the safety monitoring operations may include receive ready signals from each of the at least one client safety device. For example, the safety monitoring operations may include set i=1. For example, the safety monitoring operations may include perform safety polling operations.
For example, the safety polling operations may include poll an i-th client safety device of the cascaded multi-drop safety network by transmitting a request to the client address associated with the i-th client. For example, the safety polling operations may include receive safety and diagnostic information from the i-th client safety device. For example, the safety polling operations may include determine whether all of the at least one client safety device may be polled based on the number N saved in the first data store.
For example, the safety polling operations may include, when not all of the at least one client safety device may be polled, set i=i+1 and repeat the safety polling operations. For example, the safety polling operations may include, when all of the at least one client safety device may be polled, generate a safety status message based on safety and diagnostic information received from each of the at least one client safety device.
For example, the safety monitoring operations may include retrieve a historic guest device number of from a safety monitoring and control network configuration. For example, the historic guest device number may include a historical total number of the at least one guest safety monitoring device identified in the safety monitoring and control network configuration. For example, the safety monitoring operations may include, when the historic guest device number may be greater than the total number of the at least one guest safety monitoring device, generate an error signal to trigger the safe state operations. For example, the server device and/or the at least one client safety device comprise safety light curtains.

In a second illustrative aspect, a cascading safety network may include a server device, at least one client safety device, and/or a communication line configured to connect the server device and the at least one client safety device to form a cascaded multi-drop safety network. For example, the cascaded multi-drop safety network may include the server device connected to a first client safety device of the client safety device. For example, the cascaded multi-drop safety network may include, for each of the at least one client safety device, except the first client safety device and a last client safety device, connected to a previous client safety device and a next client safety device

For example, in operation, each of the at least one client safety device may be directly addressable by the server device through a client address uniquely assigned by the server device. For example, the server device may be triggered to perform safe state operations to automatically configure the cascaded multi-drop safety network when the server device detects a change in cascaded multi-drop network.

For example, the cascading safety network may include none, one, or more of the following features:
For example, the communication line may include N enumeration lines, where N may be the number of the at least one client safety device. For example, the 1st enumeration line connects the server device to the 1st client safety device, and the i-th enumeration line connect the (i−1)-th client node to the i-th client safety device.
For example, the safe state operations may include reset the client address of each of the client nodes to a discovery address. For example, the safe state operations may include activate the enumeration line sequentially and incrementally an i-th enumeration line from the 1st enumeration line to the N-th enumeration line, and assign a new client address to the i-th client safety device connected by the i-th enumeration line. For example, the at least one client safety device may be changeable without rebooting the server device.
For example, the safe state operations may include deactivate the communication line. For example, the safe state operations may include set i=1. For example, the safe state operations may include perform discovery operations. For example, the discovery operations may include activate an i-th enumeration line. For example, the discovery operations may include transmit a discover message comprising an assigned address to the i-th safety monitoring device via the i-th enumeration line. For example, the discovery operations may include, when no response may be received from the i-th enumeration line after a predetermined time threshold, determine that there may be N=(i−1) client safety device serially connected to the server device and save N in a first data store. For example, the discovery operations may include, when a confirmation message may be received from the i-th enumeration line, then associate an i-th assigned address with the i-th guest safety monitoring device, set i=i+1, and repeat the discovery operations.
For example, after transmitting discover message to the i-th serial enumeration line, if no confirmation message may be received from the i-th serial enumeration line after a predetermined time threshold, save an address mapping in a second data store. For example, the address mapping may include a device type and a device version of each of the at least one guest safety monitoring device connected in the cascade safety network.
For example, the service device may be configured to perform a safety monitoring operations. For example, the safety monitoring operations may include receive ready signals from each of the at least one client safety device. For example, the safety monitoring operations may include set i=1. For example, the safety monitoring operations may include perform safety polling operations.
For example, the safety polling operations may include poll an i-th client safety device of the cascaded multi-drop safety network by transmitting a request to the client address associated with the i-th client. For example, the safety polling operations may include receive safety and diagnostic information from the i-th client safety device. For example, the safety polling operations may include determine whether all of the at least one client safety device may be polled based on the number N saved in the first data store.
For example, the safety polling operations may include, when not all of the at least one client safety device may be polled, set i=i+1 and repeat the safety polling operations. For example, the safety polling operations may include, when all of the at least one client safety device may be polled, generate a safety status message based on safety and diagnostic information received from each of the at least one client safety device.
For example, the safety monitoring operations may include retrieve a historic guest device number of from a safety monitoring and control network configuration. For example, the historic guest device number may include a historical total number of the at least one guest safety monitoring device identified in the safety monitoring and control network configuration. For example, the safety monitoring operations may include when the historic guest device number may be greater than the total number of the at least one guest safety monitoring device, generate an error signal to trigger the safe state operations.
For example, the server device and/or the at least one client safety device comprise safety light curtains.

In a third illustrative example, a computer-implemented method performed by at least one processor to automatically configure and monitor a multi-drop safety monitoring and control network having an unknown N guest safety monitoring devices. For example, the method may include deactivate a communication line configured to serially connect other safety monitoring device. For example, the communication line may include a serial enumeration connection and a parallel communication connection embedded in a single cable.

For example, the method may include set i=0. For example, the method may include perform discovery operations. For example, the discovery operations may include activate an i-th enumeration line. For example, the i-th serial enumeration line may be operably couple between an (i−1)-th safety monitoring device and an i-th safety monitoring device from a host safety monitoring device. For example, an “0-th” safety monitoring device may be the server device and the i-th safety monitoring device, where i>0, indicate an i-th guest safety monitoring device serially connected to the host safety monitoring device.

For example, the discovery operations may include transmit a discover message comprising an assigned address to the i-th safety monitoring device via the i-th enumeration line. For example, the discovery operations may include, when no response may be received from the i-th enumeration line after a predetermined time threshold, determine that there may be N guest safety monitoring devices serially connected to the server device and save N in a second data store. For example, the discovery operations may include, when a confirmation message may be received from the i-th enumeration line, then (1) associate the assigned address with the i-th guest safety monitoring device, (2) set i=i+1, and (3) repeat the discovery operations.

For example, the computer-implemented method may include none, one, or more of the following features:
For example, the method may include receive ready signals from each of the N guest safety monitoring devices serially connected to the host safety monitoring device. For example, the method may include set i=1. For example, the method may include perform safety polling operations.
For example, the safety polling operations may include poll an i-th guest safety monitoring device of the N guest safety monitoring devices serially connected to the server device by transmitting a request to address i through the parallel communication connection. For example, the safety polling operations may include receive safety and diagnostic information from the i-th guest safety monitoring device. For example, the safety polling operations may include determine whether all of the N guest safety monitoring devices may be polled. For example, the safety polling operations may include, if not all of the N guest safety monitoring devices serially connected to the server device may be polled, set i=i+1 and repeat the safety polling operations, and if all of the N guest safety monitoring devices serially connected to the server device may be polled, generate a safety status message based on safety and diagnostic information received from the N guest safety monitoring devices.
For example, the parallel communication connection may include a multi-drop communication network.
For example, after transmitting discover message to the i-th enumeration line, if no confirmation message may be received from the i-th enumeration line after a predetermined time threshold, save an address mapping in a second data store. For example, the address mapping may include a device type and a device version of each of the N guest safety monitoring devices serially connected to the host safety monitoring device.
For example, the method may include retrieve a historic guest device number of from a safety monitoring and control network configuration. For example, the historic guest device number may include a historical total number K equals to a number of guest safety monitoring devices serially connected to the server device identified in the safety monitoring and control network configuration. For example, the method may include if K>N, generate an error signal.

In some examples, the cascading safety network of the first illustrative aspect may include one or more of the features in the cascading safety network of the second illustrative aspect. For example, the cascading safety network of the first illustrative aspect may include one or more features of the computer-implemented method of the third illustrative aspect.

In some examples, the cascading safety network of the second illustrative aspect may include one or more of the features in the cascading safety network of the first illustrative aspect. For example, the cascading safety network of the second illustrative aspect may include one or more features of the computer-implemented method of the third illustrative aspect.

In some examples, the computer-implemented method of the third illustrative aspect may include one or more of the features in the cascading safety network of the first illustrative aspect. In some examples, the computer-implemented method of the third illustrative aspect may include one or more of the features in the cascading safety network of the second illustrative aspect.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A cascading safety network comprising:
a server device;
at least one client safety device; and, a communication line configured to connect the server device and the at least one client safety device to form a cascaded multi-drop safety network, wherein the cascaded multi-drop safety network comprises:
the server device connected to a first client safety device of the at least one client safety device; and,
each of the at least one client safety device, except the first client safety device and a last client safety device, connected to a previous client safety device and a next client safety device, such that the communication line comprises N enumeration lines, where N is number of the at least one client safety device, wherein a 1st enumeration line connects the server device to the first client safety device, and an i-th enumeration line connect an (i−1)-th client node to an i-th client safety device, and, in operation:
each of the at least one client safety device is directly addressable by the server device through a client address uniquely assigned by the server device; and,
the server device is triggered to perform safe state operations to automatically configure the cascaded multi-drop safety network when the server device detects a change in the cascaded multi-drop safety network.

2. The cascading safety network of claim 1, wherein the safe state operations comprise:
reset the client address of each of the at least one client safety device to a discovery address; and,
activate one of the N enumeration lines sequentially and incrementally the i-th enumeration line from the 1^{st} enumeration line to an N-th enumeration line, and assign a new client address to the i-th client safety device connected by the i-th enumeration line, such that the at least one client safety device is changeable without rebooting the server device.

3. The cascading safety network of claim 1, wherein the safe state operations comprise:
deactivate the communication line;
set i=1; and,
perform discovery operations, wherein the discovery operations comprise:
activate the i-th enumeration line;
transmit a discover message comprising an assigned address to the i-th client safety device via the i-th enumeration line;
when no response is received from the i-th enumeration line after a predetermined time threshold, determine that there is a number N=(i−1) client safety device serially connected to the server device and save N in a first data store; and,
when a confirmation message is received from the i-th enumeration line, then associate an i-th assigned address with the i-th client safety device, set i=i+1, and repeat the discovery operations.

4. The cascading safety network of claim 3, wherein, after transmitting the discover message to the i-th enumeration line, if no confirmation message is received from the i-th enumeration line after the predetermined time threshold, save an address mapping in a second data store, wherein the address mapping comprises a device type and a device version of each of the at least one client safety device connected in the cascaded multi-drop safety network.

5. The cascading safety network of claim 3, wherein, the server device is configured to perform safety monitoring operations comprise:
receive ready signals from each of the at least one client safety device;
set i=1; and,
perform safety polling operations, wherein the safety polling operations comprise:
poll the i-th client safety device of the cascaded multi-drop safety network by transmitting a request to the client address associated with the i-th client safety device;
receive safety and diagnostic information from the i-th client safety device;
determine whether all of the at least one client safety device is polled based on the number N saved in the first data store;
when not all of the at least one client safety device is polled, set i=i+1 and repeat the safety polling operations; and,
when all of the at least one client safety device is polled, generate a safety status message based on safety and diagnostic information received from each of the at least one client safety device.

6. The cascading safety network of claim 5, wherein the safety monitoring operations further comprise:
retrieve a historic guest device number of from a safety monitoring and control network configuration, wherein the historic guest device number comprises a historical total number of the at least one client safety device identified in the safety monitoring and control network configuration; and,
when the historic guest device number is greater than the number N, generate an error signal to trigger the safe state operations.

7. The cascading safety network of claim 1, wherein the server device and/or the at least one client safety device comprise safety light curtains.

8. A cascading safety network comprising:
a server device;
at least one client safety device; and,
a communication line configured to connect the server device and the at least one client safety device to form a cascaded multi-drop safety network, wherein the cascaded multi-drop safety network comprises:
the server device connected to a first client safety device of the at least one client safety device; and,
each of the at least one client safety device, except the first client safety device and a last client safety device, connected to a previous client safety device and a next client safety device, wherein, in operation:
each of the at least one client safety device is directly addressable by the server device through a client address uniquely assigned by the server device; and,
the server device is triggered to perform safe state operations to automatically configure the cascaded multi-drop safety network when the server device detects a change in the cascaded multi-drop safety network.

9. The cascading safety network of claim 8, wherein the communication line comprises N enumeration lines, where N is a number of the at least one client safety device, wherein a 1st enumeration line connects the server device to the first client safety device, and an i-th enumeration line connect an (i−1)-th client node to an i-th client safety device.

10. The cascading safety network of claim 9, wherein the safe state operations comprise:
reset the client address of each of the at least one client safety device to a discovery address; and
activate one of the N enumeration lines sequentially and incrementally the i-th enumeration line from the 1st enumeration line to an N-th enumeration line, and assign a new client address to the i-th client safety device connected by the i-th enumeration line, such that the at least one client safety device is changeable without rebooting the server device.

11. The cascading safety network of claim 9, wherein the safe state operations comprise:
deactivate the communication line;
set i=1; and,
perform discovery operations, wherein the discovery operations comprise:
activate the i-th enumeration line;
transmit a discover message comprising an assigned address to the i-th client safety device via the i-th enumeration line;
when no response is received from the i-th enumeration line after a predetermined time threshold, determine that there is a number N=(i−1) client safety device serially connected to the server device and save N in a first data store; and,
when a confirmation message is received from the i-th enumeration line, then associate an i-th assigned address with the i-th client safety device, set i=i+1, and repeat the discovery operations.

12. The cascading safety network of claim 11, wherein, after transmitting discover message to the i-th enumeration line, if no confirmation message is received from the i-th enumeration line after a predetermined time threshold, save an address mapping in a second data store, wherein the address mapping comprises a device type and a device version of each of the at least one client safety device connected in the cascaded multi-drop safety network.

13. The cascading safety network of claim 11, the server device is configured to perform a safety monitoring operations comprise:
receive ready signals from each of the at least one client safety device;
set i=1; and,
perform safety polling operations, wherein the safety polling operations comprise:
poll an i-th client safety device of the cascaded multi-drop safety network by transmitting a request to the client address associated with the i-th client safety device;
receive safety and diagnostic information from the i-th client safety device;
determine whether all of the at least one client safety device is polled based on the number N saved in the first data store;
when not all of the at least one client safety device is polled, set i=i+1 and repeat the safety polling operations; and,
when all of the at least one client safety device is polled, generate a safety status message based on safety and diagnostic information received from each of the at least one client safety device.

14. The cascading safety network of claim 13, wherein the safety monitoring operations further comprises:
retrieve a historic guest device number of from a safety monitoring and control network configuration, wherein the historic guest device number comprises a historical total number of the at least one client safety device identified in the safety monitoring and control network configuration; and,
when the historic guest device number is greater than the number N, generate an error signal to trigger the safe state operations.

15. The cascading safety network of claim 1, wherein the server device and/or the at least one client safety device comprise safety light curtains.

16. A computer-implemented method performed by at least one processor to automatically configure and monitor a multi-drop safety monitoring and control network having an unknown N guest safety monitoring devices, the method comprising:
deactivate a communication line configured to serially connect other safety monitoring device, wherein the communication line comprises a serial enumeration connection and a parallel communication connection embedded in a single cable;
set i=1; and,
perform discovery operations, wherein the discovery operations comprise:
activate an i-th enumeration line, wherein a first enumeration line operably couples a host safety monitoring device to a first guest safety monitoring device, and, for i>1, the i-th enumeration line operably couples an (i−1)-th safety monitoring device to an i-th safety monitoring device, such that the N guest safety monitoring devices are serially connected to the host safety monitoring device;
transmit a discover message comprising an assigned address to the i-th safety monitoring device via the i-th enumeration line;
when no response is received from the i-th enumeration line after a predetermined time threshold, determine that there is N guest safety monitoring devices serially connected to the host safety monitoring device and save N in a first data store; and,
when a confirmation message is received from the i-th enumeration line, then (1) associate the assigned address with the i-th guest safety monitoring device, (2) set i=i+1, and (3) repeat the discovery operations.

17. The computer-implemented method of claim 16, further comprises:
receive ready signals from each of the N guest safety monitoring devices serially connected to the host safety monitoring device;
set i=1; and,
perform safety polling operations, wherein the safety polling operations comprise:
poll an i-th guest safety monitoring device of the N guest safety monitoring devices serially connected to the host safety monitoring device by transmitting a request to address i through the parallel communication connection;
receive safety and diagnostic information from the i-th guest safety monitoring device;
determine whether all of the N guest safety monitoring devices are polled; and,
if not all of the N guest safety monitoring devices serially connected to the host safety monitoring device is polled, set i=i+1 and repeat the safety polling operations, and if all of the N guest safety monitoring devices serially connected to the host safety monitoring device is polled, generate a safety status message based on safety and diagnostic information received from the N guest safety monitoring devices.

18. The computer-implemented method of claim 16, wherein the parallel communication connection comprises a multi-drop communication network.

19. The computer-implemented method of claim 16, wherein, after transmitting the discover message to the i-th enumeration line, if no confirmation message is received from the i-th enumeration line after the predetermined time threshold, save an address mapping in a second data store, wherein the address mapping comprises a device type and a device version of each of the N guest safety monitoring devices serially connected to the host safety monitoring device.

20. The computer-implemented method of claim 16, further comprises:
retrieve a historic guest device number of from a safety monitoring and control network configuration, wherein the historic guest device number comprises a historical total number K equals to a number of guest safety monitoring devices serially connected to the host safety monitoring device identified in the safety monitoring and control network configuration; and,
if K>N, generate an error signal.
